(19) United States
(12) Patent Application Publication
(10) Pub. No.: US 2012/0089813 A1
(43) Pub. Date: Apr. 12, 2012

(54) COMPUTING APPARATUS BASED ON RECONFIGURABLE ARCHITECTURE AND MEMORY DEPENDENCE CORRECTION METHOD THEREOF

(76) Inventors: Tai-Song Jin, Seoul (KR); Dong-Hoon Yoo, Seoul (KR); Bernhard Egger, Seoul (KR)

(21) Appl. No.: 13/178,350

(22) Filed: Jul. 7, 2011

(30) Foreign Application Priority Data
Oct. 7, 2010 (KR) 10-2010-0097954

(51) Int. Cl. G06F 15/76; G06F 9/02

(52) U.S. Cl. 712/30; 712/E09.002

(57) ABSTRACT

Provided are a computing apparatus based on a reconfigurable architecture and a memory dependence correction method thereof. In one general aspect, a computing apparatus has a reconfigurable architecture. The computing apparatus may include: a reconfiguration unit having processing elements configured to reconfigure data paths between one or more of the processing elements; a compiler configured to analyze instructions to generate reconfiguration information for reconfiguring one or more of the reconfigurable data paths; a configuration memory configured to store the reconfiguration information; and a processor configured to execute the instructions through the reconfiguration unit, and to correct at least one memory dependency among the processing elements.

### CROSS-REFERENCE TO RELATED APPLICATION

This application claims the benefit under 35 U.S.C. §119(a) of Korean Patent Application No. 10-2010-0097954, filed on Oct. 7, 2010, the entire disclosure of which is incorporated herein by reference for all purposes.

### TECHNICAL FIELD

The following disclosure relates a computing apparatus having a reconfigurable architecture including processing elements configured to reconfigure data paths between one or more of the processing elements.

### BACKGROUND

A reconfigurable architecture is a reconfigurable hardware configuration for a computing apparatus for processing instructions. This configuration may combine advantages of hardware for achieving quick operation speed and advantages of software for allowing flexibility in executing a multiplicity of operations, among others.

The reconfigurable architecture may provide excellent performance in loop operations in which the same operations are iteratively executed. Also, the reconfigurable architecture may provide improved performance, for instance, when it is combined with pipelining that achieves high-speed processing by allowing overlapping executions of operations.

However, when instructions are executed in parallel through a reconfigurable architecture based on pipelining, the speed of loop operations may deteriorate due to memory dependencies between one or more processing elements.

### SUMMARY

According to an aspect, a computing apparatus having a reconfigurable architecture is disclosed. The computing apparatus may include: a reconfiguration unit having processing elements configured to reconfigure data paths between one or more of the processing elements; a compiler configured to analyze instructions to generate reconfiguration information for reconfiguring one or more of the reconfigurable data paths; a memory configured to store the reconfiguration information; and a processor configured to execute the instructions through the reconfiguration unit, and to correct at least one memory dependency among the processing elements.

According to an aspect, the computing apparatus may further include a memory access queue configured to sequentially store memory addresses that the processing elements access.

According to an aspect, the processor may be configured to determine processing elements having the same memory address stored in the memory access queue as the at least one memory dependency.

According to an aspect, the processor may be configured to retrieve stored correction information, and to correct the at least one memory dependency, for each instruction iteration cycle.

According to an aspect, the processor may be configured to correct the at least one memory dependency by correcting memory addresses of the determined processing elements having the same memory address using the stored correction information.

According to an aspect, the computing apparatus may further include one or more temporal memories disposed between processing elements of the reconfiguration unit, wherein the correction information comprises one or more values previously stored in the one or more temporal memories.

According to an aspect, the correction information may include one or more values previously stored in a central register file of the processor or in register files corresponding to the processing elements of the reconfiguration unit.

According to an aspect, the memory access queue may include a plurality of memory access queues.

According to an aspect, the processing elements having the at least one memory dependency may execute the instructions using the corrected memory addresses of the determined processing elements.

According to an aspect, the processor may be configured to control the processing element execute the instructions in parallel.

According to an aspect, the compiler may be configured to analyze instructions to generate reconfiguration information for reconfiguring one or more of the reconfigurable data paths regardless of the at least one memory dependency.

According to an aspect, a method for correcting memory dependency in a computing apparatus having a reconfigurable architecture including processing elements and reconfigurable data paths between one or more of the processing elements is disclosed. The method may include: storing correction information for correcting memory dependence of the processing elements; determining at least one memory dependency among the processing elements when executing instructions; and correcting the at least one memory dependency using the correction information.

According to an aspect, the determining of the at least one memory dependency among the processing elements may include determining processing elements having the same memory address stored in a memory access queue.

According to an aspect, the memory access queue may be configured to sequentially store memory addresses which the processing elements access.

According to an aspect, the correcting of the at least one memory dependency may include correcting memory addresses of the processing elements determined to have the at least one memory dependency, for each instruction iteration cycle.

According to an aspect, the correction information may include one or more values stored in one or more temporal memories disposed between the processing elements.

According to an aspect, the correction information may include one or more values stored in a central register file of a processor or in register files of the processing elements.

According to an aspect, the instructions may be executed by the processing elements in parallel.

According to an aspect, the method may further include compiling the instructions to generate reconfiguration information for reconfiguring one or more of the reconfigurable data paths among the processing elements.

According to an aspect, the compiling may be performed regardless of the at least one memory dependency.

According to an aspect, a computing apparatus having a reconfigurable architecture apparatus having a reconfigurable architecture including processing elements and reconfigurable data paths between one or more of the processing elements is disclosed. The computing apparatus may include a processor configured to: determine at least one memory dependency among the processing elements; and correct the al least one memory dependency among the processing elements.

Other features and aspects will be apparent from the following detailed description, the drawings, and the claims.

### BRIEF DESCRIPTION OF THE DRAWINGS

FIG. 1 is a diagram illustrating a computing apparatus having a reconfigurable architecture.

FIG. 2 illustrates one example of memory dependence in a reconfigurable architecture.

FIG. 3 is a flowchart illustrating a method for correction memory dependence performed by a reconfigurable computing apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

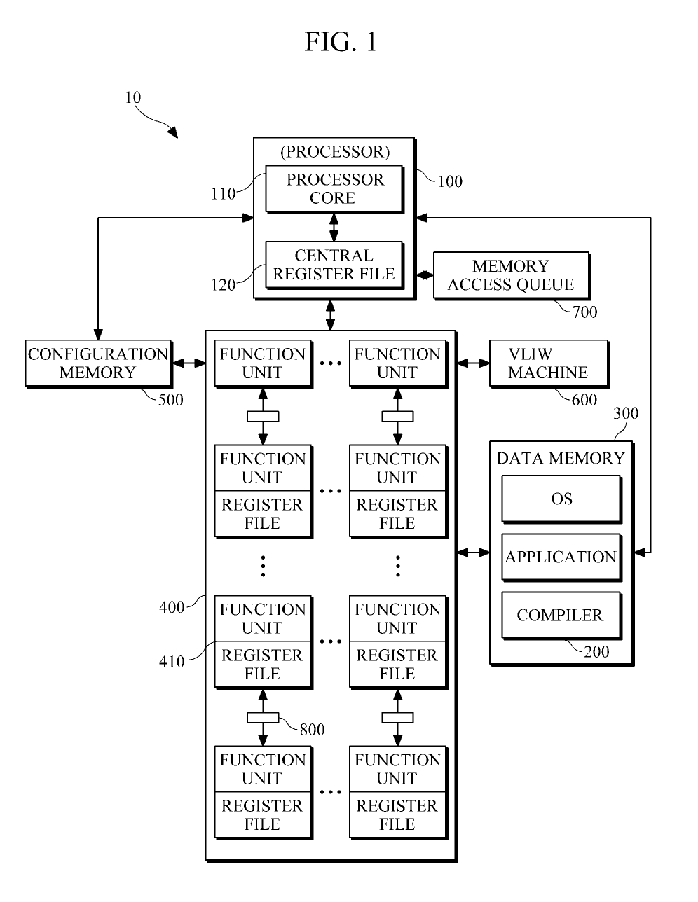

FIG. 1 is a diagram illustrating a computing apparatus 10 having a reconfigurable architecture. As shown in FIG. 1, the computing apparatus 10 may include a processor 100, a compiler 200, a data memory 300, a reconfiguration unit 400, a configuration memory 500, and a Very Long Instruction Word (VLIW) machine 600.

The processor 100, for example, may include a processor core 110 and a central register file 120. The processor core 110 may be configured to execute loop operations through one or more processing elements 410 of the reconfiguration unit 400. The processing elements 410 may be connected via reconfigurable data paths based on reconfiguration information stored in the configuration memory 500. Each processing element 410 may be configured to execute a control operation or instruction through the VLIW machine 600. In some implementations, the control operation may be one or more relatively simple data operations. The central register file 120 is configured to store results calculated by the reconfiguration unit 400 and/or intermediate results processed by the processor 100, as discussed herein.

The compiler 200 may be configured to compile a software application having instructions. In some implementations, the software application may be written with a high-level language, such as, for example, Visual Basic, Pascal, Java, C++, or the like. Data memory 300 may be configured to store the application. When the application is executed, the compiler 200 may be configured to schedule instructions and to generate reconfiguration information for reconfiguring data paths between one or more of the processing elements 410 of the reconfiguration unit 400. The reconfiguration information may be subsequently stored in the configuration memory 500.

The data memory 300 may be configured to store, for instance, an Operating System (OS), at least one software application including instructions, and/or data. The data may include, for instance, the compiler 200. Later, when an application stored in the data memory 300 is to be executed, the application is compiled by the compiler 200, instructions are scheduled, and then the scheduled instructions are executed by the processor 100.

The reconfiguration unit 400 may include one or more processing elements 410, and may be configured to reconfigure data paths among one or more processing elements 410 based on the reconfiguration information. In some embodiments, the reconfiguration unit 400 may include a Coarse Grained Array (CGA). For example, the CGA may be composed of one or more processing elements 410 each including a function unit (FU) and/or a register file (RF). The FU may be configured to perform one or more processing operations related to a particular processing element 410 to execute an instruction, and the RF may store a memory address that the particular processing element 410 will access to execute the instruction. In some instances, processing elements 410 may include a pair of a FU and a RF, and/or processing elements 410 that are adjacent to the central register file 120 may include only a FU. Memory addresses of the processing elements 410 may be stored in the temporal memories 800 for each instruction iteration cycle, as described below. Of course, it will be appreciated that the reconfiguration unit 400 may include other types of reconfigurable processors or controllers.

The configuration memory 500 may be configured to store the reconfiguration information that is used for reconfiguring data paths between one or more of the processing elements 410 of the reconfiguration unit 400. For example, the data paths among the processing elements 410 of the reconfiguration unit 400 may be reconfigured based on the reconfiguration information stored in the configuration memory 500.

The VLIW machine 600 may be configured to detect instructions that can be simultaneously executed by a control process, rearrange the instructions into an instruction code, and execute the instruction code. In some instances, the control process may include a processor that configured to provide a simple data flow. Of course, it will be appreciated that other processor technologies may be used alternatively or additionally to a VLIW-based machine, in various embodiments.

The computing apparatus 10 may be configured to perform various processing to prevent the speed of loop operations from decreasing due to memory dependencies between one or more of the processing elements 410 included in the reconfiguration unit 400. First, the compiler 200 may analyze the compiled instructions to generate reconfiguration information that will be used for reconfiguring one or more data paths between the processing elements 410 of the reconfiguration unit 400. This operation may occur, for instance, regardless of any memory dependence between the processing elements 410. The reconfiguration information may then be stored in the configuration memory 500. Next, the processor 100 may execute the instructions. For example, the instructions may be executed in parallel through the reconfiguration unit 400 which has been reconfigured based on the reconfiguration information. To correct for any memory dependence between processing elements 410, the processor 100 may be configured to first determine at least one memory dependency between the processing elements 410 This operation may improve the speed of loop operations.

According to an embodiment, in order to determine a memory dependency between the processing elements 410, the computing apparatus 10 may analyze a memory access queue 700 that is configured to store memory addresses that the individual processing elements 410 will access to execute an instruction for each instruction iteration cycle. The memory addresses may be sequentially stored in the memory access queue 700, for instance, as they are pipelined.

“Pipelining,” as used herein, refers to a set of data processing elements connected in series (i.e., the pipeline), in which the output of one processing element is the input of another processing element. The elements of a pipeline may be executed in parallel. In some instances, a temporary or buffer storage may be inserted between processing elements for this purpose.

The memory access queue 700 may be, for example, a volatile memory or a register that is configured to temporarily store data corresponding to memory addresses for processing elements 410 for each instruction iteration cycle. In some implementation, a plurality of memory access queues 700 may be provided.

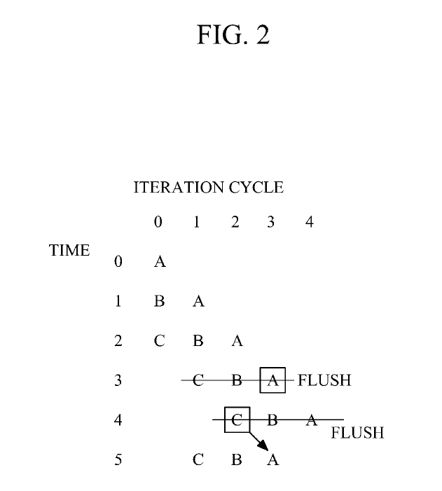

FIG. 2 illustrates one example of memory dependence in a reconfigurable architecture. In FIG. 2, the horizontal direction represents instruction iteration cycles, and the vertical direction represents time of the processor 100. The following descriptions will be given with reference to FIGS. 1 and 2.

Referring to FIG. 2 instructions “A,” “B,” and “C” are pipelined for each instruction iteration cycle. The memory addresses that processing elements 410 will access to execute the instructions “A,” “B,” and “C” are sequentially stored in the memory access queue 700 for each instruction iteration cycle. Of course, it should be appreciated that the particular instructions, instruction iteration cycles, and/or times are merely exemplary, and that different instructions and iterations are possible than depicted in FIG. 2.

As shown in FIG. 2, at time “0”, the memory address that a particular processing element 410 will access to execute instruction “A” may be initially stored for instruction iteration cycle “0” in memory access queue 700. Next, at time “1,” the memory address that a particular processing element 410 will access to execute instruction “B” may be sequentially stored for instruction iteration cycle “0” and the memory address that a particular processing element 410 will access to execute instruction “A” may be sequentially stored for instruction iteration cycle “1” in memory access queue 700. And at time “2,” the memory address that a particular processing element 410 will access to execute instruction “C” may be sequentially stored for instruction iteration cycle “0” and the memory address that a particular processing element 410 will access to execute instruction “B” may be sequentially stored for instruction iteration cycle “1” and the memory address that a particular processing element 410 will access to execute instruction “A” may be sequentially stored for instruction iteration cycle “2” in memory access queue 700. And at time “3,” the memory address that a particular processing element 410 will access to execute instruction “C” may be sequentially stored for instruction iteration cycle “1” and the memory address that a particular processing element 410 will access to execute instruction “B” may be sequentially stored for instruction iteration cycle “2” and the memory address that a particular processing element 410 will access to execute instruction “A” may be sequentially stored for instruction iteration cycle “3” in memory access queue 700. And at time “4,” the memory address that a particular processing element 410 will access to execute instruction “C” may be sequentially stored for instruction iteration cycle “2” and the memory address that a particular processing element 410 will access to execute instruction “B” may be sequentially stored for instruction iteration cycle “3” and the memory address that a particular processing element 410 will access to execute instruction “A” may be sequentially stored for instruction iteration cycle “4” in memory access queue 700.

Now consider a situation in which instruction “A” corresponding to time “3” with respect to an instruction iteration cycle “3” has the same memory address as instruction “C” corresponding to time “4” with respect to instruction iteration cycle “2.” For ease of explanation, the memory address in memory access queue 700 that is common to both instructions “A” and “C” has been outlined in FIG. 2.

If the memory address of instruction “C” corresponding to the time “4” with respect to instruction iteration cycle “2” has to be first accessed, then the memory address of instruction “A” corresponding to the time “3” with respect to instruction iteration cycle “3” will also be accessed in order to perform correct operation. However, due to pipelining, the memory address of instruction “A” corresponding to the time “3” with respect to the instruction iteration cycle “3” must be first accessed, in order for the memory address of the instruction “C” corresponding to the time “4” with respect to the instruction iteration cycle “2” to be accessed. Accordingly, correct operation execution of instructions may be impossible due to a memory dependency on the same memory address in the memory access queue 700.

In order to reconcile this problem, the processor 100 may be configured to determine at least one memory dependency when the processing elements 410 have the same memory address stored in the memory access queue 700. In one of more embodiments, the processor 100 may be configured to store correction information for correcting at least one memory dependency among the processing elements 410, for each instruction iteration cycle. Moreover, the processor 100 may be further configured to correct the at least one memory dependency by correcting the memory addresses of the processing elements 410 based on the stored correction information.

In one embodiment, the correction information may include one or more values stored in temporal memories 800 disposed between the processing elements 410 of the reconfiguration unit 400. For example, the correction information may include all values stored in the plurality of temporal memories 800. The stored values may be modified at a later time, in some implementations, as necessary.

When there are processing elements 410 having the same memory address stored in the memory access queue 700, those memory addresses may be flushed. “Flushing,” as used herein, refers to clearing or removing the memory addresses from the memory access queue 700. Flushing operations are depicted as horizontal lines in FIG. 2.

Memory addresses of processing elements 410 having later instruction iteration cycles may then be updated. In one embodiment, this update operation may include using the memory addresses of the processing elements 410 previously stored in the temporal memories 800. The updated memory addresses may then be stored in another, different area of the memory access queue 700, thereby correcting a memory dependency between the processing elements. This updating operation is depicted as a downwardly-angled arrow in FIG. 2 between time steps “4” and time “5.” For example, at time “5,” the memory address at instruction iteration cycle “3,” is updated for instruction “A,” based on stored correction information for time “3.” In addition, at that instance, the memory addresses at instruction iteration cycles “2” and “1” are updated for instructions “B” and “C,” respectively based on stored correction information for time “3.” It will be appreciated, of course, that the updated memory addresses at time “5” may be at different locations within the memory access queue 700 than those depicted in FIG. 2.

The correction information may include, for instance, one or more values previously stored in the central register file 120 and/or in the register files (RF) of the corresponding processing elements 410 of the reconfiguration unit 120. The stored values may become modified at a later time, in some implementations, as necessary.

In one or more embodiments, the memory addresses of the processing elements 410 may be stored in the central register file 120 and/or in the register files (RF) of the processing elements 410 for each instruction iteration cycle. When there are processing elements determined that have the same memory address stored in the memory access queue 700, these memory addresses will be flushed. The flushing operations are depicted as horizontal lines in FIG. 2.

Next, memory addresses of processing elements 410 having later instruction iteration cycles are updated using the memory addresses of the processing elements 410, stored in the central register file 120 and/or in the register files (RF) of the processing elements 410. The updated memory addresses may then be stored in another, different area of the memory access queue 700, thereby correcting memory dependence between the processing elements.

By correcting memory dependencies between the processing elements 410, instructions may be executed using the corrected memory addresses of the processing elements 410 so that correct operation executions can be achieved. Moreover, by correcting memory dependency between the processing elements 410 included in the reconfiguration unit 400, the speed of loop operations may be increased. This in turn may improve processing performance of the computing apparatus 10 having the reconfigurable architecture.

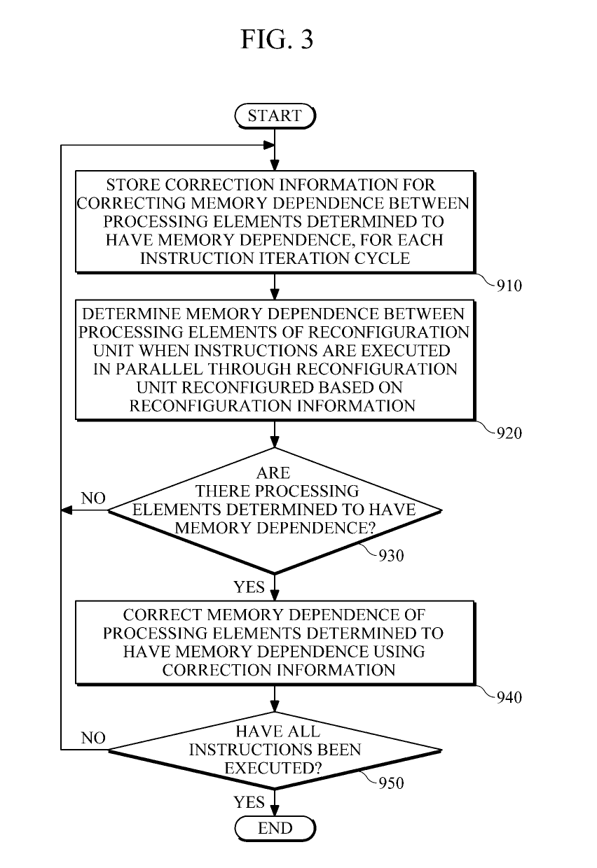

FIG. 3 is a flowchart illustrating a method for correcting memory dependence performed by a reconfigurable computing apparatus, such as the computing apparatus 10 illustrated in FIG. 1. The following descriptions will be described with reference to FIGS. 1 and 3.

In operation 910, the processor 100 stores correction information for correcting memory dependence among processing elements 410. For example, the correction information may include one or more values previously stored in the temporal memories 800. As shown in FIG. 1, the temporal memories 800 may be disposed between the adjacent pairs of processing elements 410 of the reconfiguration unit 400 of the reconfigurable computing apparatus 10.

Alternatively or additionally, the correction information may include one or more values previously stored in the central register file 120 and/or in the register files (RF) of the processing elements 410, in some implementations. The stored values may be modified at a later time, in some instances, as necessary.

Next, in operation 920, the processor 100 determines at least one memory dependency among processing elements 410 when instructions are executed through the reconfiguration unit 400 reconfigured based on reconfiguration information. Execution of the instructions may be in parallel, in one or more implementations.

If there are processing elements having the same memory address stored in the memory access queue 700, the processor 100 may determine or otherwise conclude that the processing elements have a memory dependency. The memory access queue 700 may sequentially store memory addresses which the processing elements 410 can access. And the instructions may be executed (e.g., in parallel) based on reconfiguration information.

In operation 930, a determination is made whether there are processing elements 410 having at least one memory dependency. If “YES,” then the method proceeds to operation 940. Otherwise, if “NO,” then the method returns to operation 910 to store or update the correction information, as necessary for continued processing.

In operation 940, the at least one memory dependency of the determined processing elements 410 may be corrected using the correction information stored in operation 910. For example, the correction information may include previously stored memory addresses of the processing elements.

Next in operation 950, a determination is made whether all instructions have been executed. If “YES,” then the method ends. Otherwise, if “NO,” then the method returns to operation 910 for each additional instruction.

By correcting at least one memory dependency between the processing elements 410 included in the reconfiguration unit 400 based on the reconfigurable architecture, the speed of loop operations may be increased. This in turn may improve the processing performance of the reconfigurable computing apparatus 10.

In some embodiments, the processes, functions, methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data, for example, in some embodiments.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A computing apparatus having a reconfigurable architecture, the computing apparatus comprising:
a reconfiguration unit having processing elements configured to reconfigure data paths between one or more of the processing elements;
a compiler configured to analyze instructions to generate reconfiguration information for reconfiguring one or more of the reconfigurable data paths;
a memory configured to store the reconfiguration information; and
a processor configured to execute the instructions through the reconfiguration unit, and to correct at least one memory dependency among the processing elements.

2. The computing apparatus of claim 1, further comprising a memory access queue configured to sequentially store memory addresses that the processing elements access.

3. The computing apparatus of claim 2, wherein the processor is configured to determine processing elements having the same memory address stored in the memory access queue as the at least one memory dependency.

4. The computing apparatus of claim 1, wherein the processor is configured to retrieve stored correction information, and to correct the at least one memory dependency, for each instruction iteration cycle.

5. The computing apparatus of claim 4, wherein the processor is configured to correct the at least one memory dependency by correcting memory addresses of the determined processing elements having the same memory address using the stored correction information.

6. The computing apparatus of claim 4, further comprising one or more temporal memories disposed between processing elements of the reconfiguration unit,
wherein the correction information comprises one or more values previously stored in the one or more temporal memories.

7. The computing apparatus of claim 4, wherein the correction information comprises one or more values previously stored in a central register file of the processor or in register files corresponding to the processing elements of the reconfiguration unit.

8. The computing apparatus of claim 2, wherein the memory access queue comprises a plurality of memory access queues.

9. The computing apparatus of claim 5, wherein the processing elements having the at least one memory dependency execute the instructions using the corrected memory addresses of the determined processing elements.

10. The computing apparatus of claim 1, wherein the processor is configured to control the processing elements to execute the instructions in parallel.

11. The computing apparatus of claim 1, wherein the compiler is configured to analyze instructions to generate reconfiguration information for reconfiguring one or more of the reconfigurable data paths regardless of the at least one memory dependency.

12. A method for correcting memory dependency in a computing apparatus having a reconfigurable architecture including processing elements and reconfigurable data paths between one or more of the processing elements, the method comprising:
storing correction information for correcting memory dependence of the processing elements;
determining at least one memory dependency among the processing elements when executing instructions and
correcting the at least one memory dependency using the correction information.

13. The method of claim 12, wherein the determining of the at least one memory dependency among the processing elements comprises determining processing elements having the same memory address stored in a memory access queue.

14. The method of claim 13, wherein the memory access queue is configured to sequentially store memory addresses which the processing elements access.

15. The method of claim 12, wherein the correcting of the at least one memory dependency comprises correcting memory addresses of the processing elements determined to have the at least one memory dependency, for each instruction iteration cycle.

16. The method of claim 12, wherein the correction information comprises one or more values stored in one or more temporal memories disposed between the processing elements.

17. The method of claim 12, wherein the correction information comprise one or more values stored in a central register file of a processor or in register files of the processing elements.

18. The method of claim 12, wherein the instructions are executed by the processing elements in parallel.

19. The method of claim 12, further comprising: compiling the instructions to generate reconfiguration information for reconfiguring one or more of the reconfigurable data paths among the processing elements.

20. The method of claim 19, wherein the compiling is performed regardless of the at least one memory dependency.

21. A computing apparatus having a reconfigurable architecture apparatus having a reconfigurable architecture including processing elements and reconfigurable data paths between one or more of the processing elements, the computing apparatus comprising:
a processor configured to:
determine at least one memory dependency among the processing elements; and
correct the al least one memory dependency among the processing elements.
